(19) United States
(12) Patent Application Publication
(10) Pub. No.: US 2024/0378405 A1
(43) Pub. Date: Nov. 14, 2024

(54) WEB-MEDIATED TRANSACTIONS USING QUICK RESPONSE CODES AND TRACKING OF THE SAME

(71) Applicant: Blue Sparq, Inc., Cape Coral, FL (US)

(72) Inventors: Karthikeyan SHANKAR, Cape Coral, FL (US); Jameel Abdul AHED, Cape Coral, FL (US); Siddhartha ELUPPAI SRIVATSAN, Cape Coral, FL (US)

(73) Assignee: Blue Sparq, Inc., Cape Coral, FL (US)

(21) Appl. No.: 18/784,070

(22) Filed: Jul. 25, 2024

Related U.S. Application Data
(63) Continuation of application No. PCT/US2023/061395, filed on Jan. 26, 2023.
(60) Provisional application No. 63/303,646, filed on Jan. 27, 2022.

(51) Int. Cl. G06K 7/14; G06F 3/0482; G06F 3/0484; G06F 3/0488; G06K 19/06

(52) U.S. Cl. CPC G06K 7/1417; G06K 19/06037; G06F 3/0482; G06F 3/0484; G06F 3/0488

(57) ABSTRACT

A method includes receiving, at a processor of a first mobile compute device, a user input including a representation of an amount. The user input and the first mobile compute device are associated with a first user. The method also includes generating, at the processor of the first mobile compute device, a quick response (QR) code based on the user input, and causing display of the QR code via a graphical user interface (GUI) of the first mobile compute device such that the QR code is scannable by a second mobile compute device associated with a second user. The method also includes receiving (e.g., from a payment gateway) a signal representing a response message associated with the second user, the response message including an indication of a payment status for a payment initiated based on the QR code and authorized by the second user.

### CROSS-REFERENCE TO RELATED APPLICATIONS

This application is a bypass continuation of International Application No. PCT/US2023/061395, filed Jan. 26, 2023 and titled “WEB-MEDIATED TRANSACTIONS USING QUICK RESPONSE CODES AND TRACKING OF THE SAME,” which claims priority to and the benefit of U.S. Provisional Patent Application No. 63/303,646, filed Jan. 27, 2022 and titled “WEB-MEDIATED TRANSACTIONS USING QUICK RESPONSE CODES AND TRACKING OF THE SAME,” the contents of each of which are incorporated by reference herein in their entireties.

### FIELD

The present disclosure relates to the field of electronic commerce (“e-commerce”), and in particular, to web-mediated processing of transactions using quick response (QR) codes.

### BACKGROUND

Face-to-face commerce, particularly when impromptu in nature (e.g., at yard sales, farmer's markets, etc.), often involves the preparation of manual invoices and the physical exchange of currency or the swipe of a credit card in a credit card reader (e.g., a Square® credit card reader). Increasingly, consumers are not carrying cash and/or are reluctant to provide their credit cards in a live setting. Thus, a need exists for a coordinated transaction platform for face-to-face commerce that eliminates the use of currency or credit cards.

### SUMMARY

Embodiments of the present disclosure facilitate the generation of quick response (QR) codes and the web-mediated processing of contactless transactions using the QR codes. In some embodiments, a method includes receiving, at a processor of a first mobile compute device (e.g., a “point-of-sale” mobile compute device), a user input including a representation of an amount (and, optionally, a comment and/or an invoice identifier). The user input and the first mobile compute device are associated with a first user. The method also includes generating, at the processor of the first mobile compute device, a quick response (QR) code based on the user input, and causing display of the QR code via a graphical user interface (GUI) of the first mobile compute device such that the QR code is scannable by a second mobile compute device associated with a second user. The method also includes receiving, at the processor of the first mobile compute device, a signal representing a response message associated with the second user, the response message including an indication of a payment status for a payment initiated based on the QR code and authorized by the second user. The response message can be, for example, a response received from a payment gateway.

In some embodiments, a method includes scanning a quick response (QR) code using a camera of a second mobile compute device (e.g., a “guest” mobile compute device), while the QR code is displayed via a graphical user interface (GUI) of a first mobile compute device different from the second mobile compute device. The method also includes causing display of a first webpage via a GUI of the second mobile compute device in response to scanning the QR code. The first webpage includes a representation of a price, a representation of at least one product, and an interactive graphical object. After causing display of the first webpage, an interaction with the interactive graphical object by a user of the second mobile compute device is detected. The method also includes causing display of a second webpage via the GUI of the second mobile compute device, in response to detecting the interaction with the interactive graphical object. The second webpage includes a plurality of representations of payment options and an interactive graphical object. The method also includes initiating a payment transaction via a processor of the second mobile compute device in response to detecting an interaction with a representation of a payment option from the plurality of representations of payment options and an interaction with the interactive graphical object of the second webpage. The method also includes receiving, at the processor of the second mobile compute device and from a server, a signal representing a transaction response message associated with the transaction.

In some embodiments, a method includes automatically generating, at the processor of the first mobile compute device, a quick response (QR) code representing an amount associated with one of a product or a service, and causing display of the QR code via a graphical user interface (GUI) of a first mobile compute device associated with a first user, such that the QR code is scannable by a second mobile compute device associated with a second user. The method also includes receiving, at the processor of the first mobile compute device, a signal representing a response message associated with the second user. The response message includes an indication of a payment status for a payment initiated based on the QR code and authorized by the second user.

### BRIEF DESCRIPTION OF THE DRAWINGS

FIG. 1 is a diagram showing data flows within a system for processing web-mediated transactions, according to some embodiments.

FIG. 2 is a system diagram showing a system for processing web-mediated transactions, according to some embodiments.

FIG. 3 is a flow diagram showing a first method for processing web-mediated transactions, from the point of view of a “point-of-sale” mobile compute device, according to some embodiments.

FIG. 4 is a flow diagram showing a method for processing web-mediated transactions, from the point of view of a “guest” mobile compute device, according to some embodiments.

FIG. 5 is a flow diagram showing a second method for processing web-mediated transactions, from the point of view of a “point-of-sale” mobile compute device, according to some embodiments.

FIGS. 6A-6F show an example sequence of information displayed via graphical user interfaces (GUIs) of a point-of-sale mobile compute device and a guest mobile compute device during a transaction, according to an embodiment.

FIGS. 7A-7E show an example sequence of actions taken and information displayed via GUIs of a point-of-sale mobile compute device and a guest mobile compute device during a transaction, according to an embodiment.

### DETAILED DESCRIPTION

Embodiments of the present disclosure facilitate “on-the-fly” generation of quick response (QR) codes and the web-mediated processing of contactless transactions using the QR codes. Systems and methods set forth herein can be initiated by a user at any time, for example via interactions via a graphical user interface (“GUI”) of a mobile compute device (e.g., a smartphone, tablet, laptop, etc.), the GUI displaying a website. The QR code based transaction methods set forth herein offer various technical advantages over known software-based transaction regimes. For example, by virtue of the transaction participants being co-located in a given geographic location and able to communicate with another directly (including, for example, the purchaser participant being able to manually scan a QR code when displayed on the seller participant's mobile compute device), the transaction steps can be completed without direct communication, connection, and/or coordination (e.g., synchronization, for example by Bluetooth®) of the mobile compute devices of the transaction participants. In addition, the QR code based transaction methods set forth herein facilitate the completion of automatic payments without the purchaser participant needing to manually enter any financial information during the transaction, and payment confirmations are automatically generated and sent to the mobile compute devices of both transaction participants without any additional actions being taken by the transaction participants. Overall, the transactions facilitated by the present disclosure can include fewer steps, with fewer inputs provided by the transaction participants, and with greater flexibility in that the transaction details can be defined/specified contemporaneously with the transaction, for example in response to a live negotiation and/or agreement between the parties.

In some embodiments, a user (e.g., a merchant or vendor, also referred to herein as a “point-of-sale” (“POS”) user) completes a registration, or “onboarding,” process by navigating, within a browser of a mobile compute device, to a website, and entering user details such as name, business description, username, password, contact information (e.g., email address, phone number, address, etc.), back account information, credit card information, payment platform credentials, settings, preferences, etc. Once registration has been completed, the user can be regarded as a registered user, and optionally is assigned a user-specific uniform resource locator (URL) that is specific to that registered user. Subsequent to registration, when the registered user seeks to enter into a transaction with a customer (also referred to herein as a “guest user”), the registered user can navigate to his/her user-specific URL and enter, at the website referenced by the URL, one or more details associated with the desired transaction. As used herein, the term “transaction” can refer to a transfer or exchange of one or more of currency, product ownership, a product license, service ownership, and a service license, in one direction (i.e., a transfer from a seller participant to a purchaser participant) or in two directions (e.g., a transfer of product ownership, a product license, service ownership, and/or a service license from a seller participant to a purchaser participant and a transfer of currency from a purchaser participant to a seller participant).

In some implementations, the one or more details includes only a price/dollar amount. In other implementations, the details include a price and one or more of a product description, a service description, a quantity, a date, a buyer name, a buyer account number, and/or a transaction identifier. After entering the one or more details, the registered user can select an object (e.g., a graphical object, user-interface element, a glyph, etc., such as a “SUBMIT” button) within the website to trigger the generation of a QR code, which in turn is rendered on the registered user's screen (e.g., via the website). A guest user can then use his/her mobile compute device to scan the QR code displayed on the registered user's mobile compute device. Scanning the QR code causes a browser of the mobile compute device of the guest user to automatically navigate to a webpage displaying a message (e.g., “PAY $1.00”) prompting the user to pay for the transaction, and rendering representations of one or more payment methods (e.g., PayPal®, Venmo®, Zelle®, Apple Wallet®, Cash App®, Google Pay®, etc.).

In some implementations, the transaction is processed without invoking a dedicated software application (“app”).

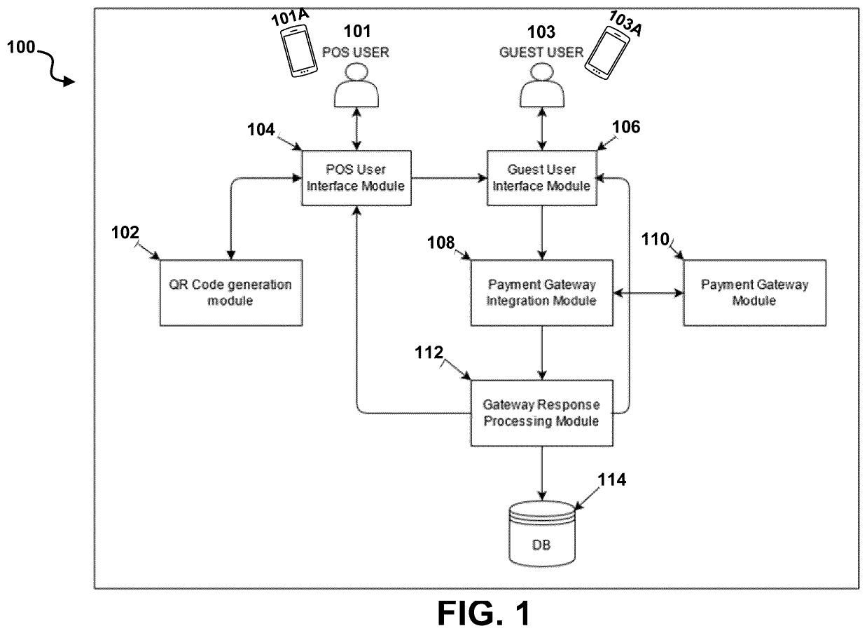

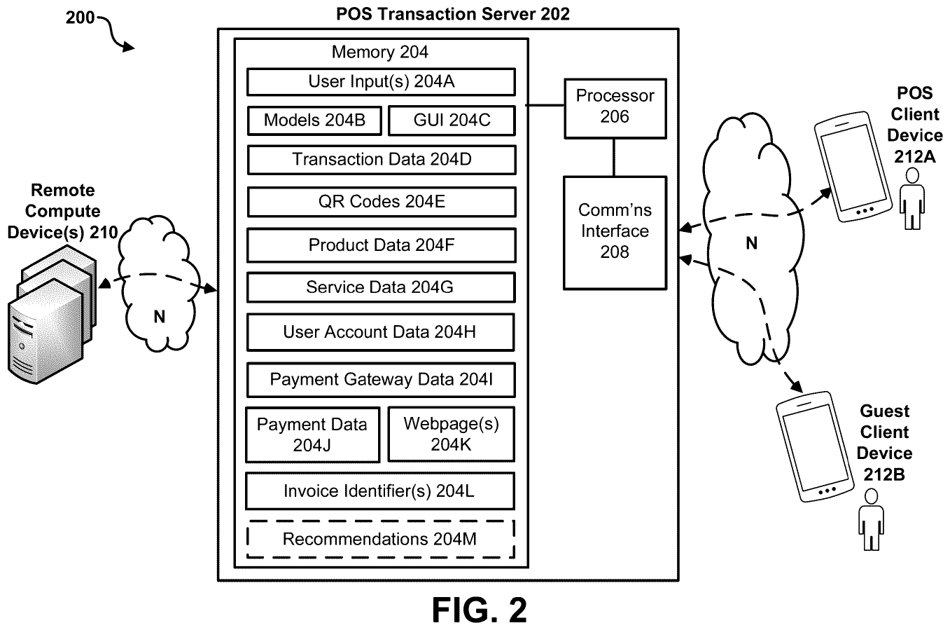

FIG. 1 is a diagram showing data flows within a system for processing contactless, web-mediated, POS transactions, using QR codes, according to some embodiments. As shown in FIG. 1, the system 100 includes a QR code generation module 102, a POS user interface module 104, a guest user interface module 106, a payment gateway integration module 108, a payment gateway module 110, and a gateway response processing module 112 operably coupled to a database 114. Each of the QR code generation module 102, the POS user interface module 104, the guest user interface module 106, the payment gateway integration module 108, the payment gateway module 110, and the gateway response processing module 112 can be implemented in hardware and/or software. The QR code generation module 102 is operably coupled to the POS user interface module 104, which in turn is operably coupled to each of the guest user interface module 106 and the gateway response processing module 112. The guest user interface module 106 is also operably coupled to the payment gateway integration module 108 and the gateway response processing module 112. The payment gateway integration module 108 is also operably coupled to the payment gateway module 110 and the gateway response processing module 112. In some implementations, at least the payment gateway integration module 108 and the gateway response processing module 112 reside in a centralized server that is in network communication with one or more client devices (e.g., POS client device 212A and/or guest client device 212B of FIG. 2, discussed below).

The POS user 101 can be associated with a POS compute device 101A (e.g., a mobile compute device such as a smartphone), and the guest user 103 can be associated with a guest compute device 103A (e.g., a mobile compute device such as a smartphone). Any of the QR code generation module 102, the POS user interface module 104, the guest user interface module 106, the payment gateway integration module 108, the payment gateway module 110, and the gateway response processing module 112 can be implemented in software residing in one or both of the POS compute device 101A and the guest compute device 103A, or can be accessible (e.g., via wireless or wired communication with a remote compute device, such as a server) by one or both of the POS compute device 101A and the guest compute device 103A.

The QR code generation module 102 is configured to receive user inputs from the POS user interface module 104. The user inputs can include data such as one or more amounts of money (i.e., prices), one or more comments, one or more invoice numbers, etc. The user inputs can be entered by the POS user 101 via a GUI of the POS compute device 101A, and received at the POS user interface module 104. The GUI can be implemented via software resident on the POS compute device 101A and can display at least a portion of a webpage and/or data provided by the webpage. The QR code generation module 102 is also configured to convert the user inputs into a QR code and transmit the QR code to the POS user interface module 104 for display via the POS compute device 101A. In some implementations, the QR code is transmitted to the POS user interface module 104 without any other data (e.g., payload data) being transmitted, thereby increasing the efficiency of the transmission of transaction details, as compared with known approaches. In some implementations, wireless signals representing the QR code can be exchanged among multiple POS compute devices 101A (e.g., for display to multiple guest users).

The POS user interface module 104 is configured to cause display of the QR code generated by the QR code generation module 102 via the GUI of the POS compute device 101A. In some implementations, the POS user interface module 104 is also configured to cause display of a status of one or more transactions to the POS user 101 via the GUI.

The guest user interface module 106 can reside in the guest compute device 103A and can be configured to scan the QR code displayed via the GUI of the POS compute device 101A. The scan can be initiated, for example, by the guest user 103 turning on the camera of the guest compute device 103A and/or in response to a user request/selection made via a GUI of the guest compute device 103A. The GUI can be implemented software resident on the POS compute device 103A. Scanning the QR code can result in a browser opening in the guest compute device 101A and/or can result in the browser navigating to a webpage (or can result in a change to what is displayed via the GUI) displaying, for example, a total amount of money owed by the guest, one or more comments, and/or any other data or subset of the data of the user inputs originally received at the POS user interface module 104. The webpage or other GUI can also include a user-selectable object (e.g., a PAY button) by which the guest user 103 can agree to a transaction and trigger a payment. In response to the guest user 103 selecting the user-selectable object (e.g., by clicking the PAY button), the guest user interface module 106 can cause display, via the guest compute device 101A, of one or more user-selectable payment methods (e.g., credit card, PayPal®, Google Pay®, Apple Pay®, Venmo®, Zelle®, Apple Wallet®, Cash App®, etc.). In response to the guest user 103 selecting one of the displayed user-selectable payment methods and successfully completing the payment, the guest user interface module 106 can generate and send a response message (e.g., a payment confirmation message), for example in the form of a token such as a software token or “soft token,” to the payment gateway integration module 108.

In some implementations, credit card payment is selected by the guest user, and the guest user completes the payment by one or more of entering at least a subset of digits of a credit card number, entering an expiration date of the credit card number, or clicking on a “submit” button. In response to the completion of the payment, a token (e.g., a nonce token) is automatically created/generated and sent to a centralized server (e.g., including the payment gateway integration module 108 and the gateway response processing module 112). In response to receiving the token, the centralized server can, in turn, forward the token to an appropriate payment gateway (e.g., a payment gateway associated with the type of credit card used by the guest user to complete the payment). Once the payment gateway has processed the token, the payment gateway can send to the centralized server a result message (e.g., indicating SUCCESS or FAIL). The centralized server can then cause display of the result message to the user (e.g., via the guest compute device 103A).

In some implementations, rather than including the user-selectable object (e.g., a PAY button), a user preference or user-adjustable setting can be stored or received at the guest compute device 101A, such that payment is automatically/autonomously triggered without further intervention from the guest user 103, in response to scanning the QR code with the guest compute device 103A. The user preference or user-adjustable setting can specify, for example, a preferred payment method, a preferred sequence of payment methods, a payment maximum, a list of approved vendors, etc. In other implementations, rather than including the one or more user-selectable payment methods, the user preference or the user-adjustable setting can be applied at the guest compute device 101A, such that payment is automatically/autonomously triggered without further intervention from the guest user 103, in response to the guest user selecting the user-selectable object (e.g., a PAY button).

The payment gateway integration module 108 serves as a communication bridge between the payment gateway module 110 and the gateway response processing module 112. The payment gateway integration module 108 is configured to send the result/token generated by the guest user interface module 106 to the payment gateway module 110. In response to receiving a response (“gateway response”) from the payment gateway module 110 indicating completion of the payment, the payment gateway integration module 108 sends a signal representing the gateway response to the gateway response processing module 112 to indicate that payment has been completed. The gateway response processing module 112 is configured to cause storage of the gateway response in the database 114, and also to send a signal representing the gateway response and/or an indication that the transaction has been completed to (1) the POS user interface module 104 (e.g., for display via the GUI of the POS compute device 101A) and (2) to the guest user interface module 106 (e.g., for display via the GUI of the guest compute device 103A). In some implementations, a representation of the gateway response and/or transaction completion is displayed via each of the GUI of the POS compute device 101A and the GUI of the guest compute device 103A simultaneously or substantially concurrently.

In some implementations, one or more of the QR code generation module 102, the POS user interface module 104, the guest user interface module 106, the payment gateway integration module 108, the payment gateway module 110, or the gateway response processing module 112 can reside in a centralized server configured to track and store data associated with the transactions initiated and/or performed using the system 100.

In some implementations, at least one of the POS user interface module 104, the guest user interface module 106, the payment gateway integration module 108, and the gateway response processing module 112 is configured to coordinate what is displayed via the GUI of the POS compute device 101A and the GUI of the guest compute device 103A. The coordinating can include, for example, displaying the QR code via the GUI of the POS compute device 101A while the guest user completes payment for the transaction via the GUI of the guest compute device 103A. Alternatively or in addition, the coordinating can include displaying a “successful payment” message via both the GUI of the POS compute device 101A and the GUI of the guest compute device 103A at the same time (or at least partially overlapping in time, simultaneously, or substantially concurrently). For example, similar to the discussion above, when a payment is selected by the guest user, and the guest user completes the payment, a token (e.g., a nonce token) is automatically created/generated in response to the completion of the payment and sent from the guest user interface module 106 to the payment gateway module 110. Once the payment gateway module 110 has processed the token, the payment gateway module 110 can send a result message (e.g., indicating SUCCESS or FAIL) to the gateway response processing module 112. The gateway response processing module 112 can then forward the result message to each of the POS user interface module 104 and the guest user interface module 106, to cause display of the result message via each of the POS compute device 101A and the guest compute device 103A. Upon seeing both messages displayed via both compute devices (101A, 103A), a store clerk may, for example, feel comfortable giving the product to the guest user/customer knowing that the guest user/customer has paid.

FIG. 2 is a system diagram showing a system for processing web-mediated transactions, according to some embodiments. As shown in FIG. 2, the system 200 includes a POS transaction server 202, in communication via a wireless or wired communications network N with multiple client devices (POS client device 212A and guest client device 212B) and in communication via either the same or a different wireless or wired communications network N with one or more remote compute devices 210. The POS transaction server 202 includes a processor 206 operably coupled with a memory 204 and a communications interface 208 (e.g., a transceiver configured to transmit and receive signals over the communications network N). The memory 204 stores one or more user inputs 204A, one or more models 204B (e.g., one or more machine learning models), a graphical user interface 204C, transaction data 204D, QR codes 204E, product data 204F, service data 204G, user account data 204H, payment gateway data 204I, payment data 204J, one or more webpages 204K, one or more invoice identifiers 204L, and optionally one or more recommendations 204M. The optional one or more recommendations 204M can be, for example, generated using the one or more models 204B, and can reference one or more products and/or one or more services recommended for a particular user. The POS client device 212A can be similar to the POS compute device 101A described in reference to FIG. 1 above, and the guest client device 212B can be similar to the guest compute device 103A described in reference to FIG. 1 above. Although shown in FIG. 2 as being in network communication with the POS transaction server 202, the POS client device 212A and the guest client device 212B may (alternatively or in addition) be in peer-to-peer communication with each other, for example via a Bluetooth® connection, peer-to-peer near field communication (NFC), WiFi® direct, a mesh network such as Zigbee®, etc.

During operation of the system 200, a guest user associated with guest client device 212B may desire to purchase a good and/or service from a POS user associated with POS client device 212A. The guest user and the POS user may discuss/negotiate a price for the good and/or service, in real-time/“live” (e.g., face-to-face, via a telephone conversation, via short message service (SMS) text messaging, etc.). Optionally, product data 204F and/or invoice identifiers 204L may be retrieved from the memory 204 of the POS transaction server 202 by the POS client device 212A or otherwise sent from the POS transaction server 202 to the POS client device 212A. Once agreement on the price has been reached, the POS user may enter the price and, optionally, one or more of comments, descriptions of the good and/or service, invoice number, date, time, location information, guest user information (e.g., contact information), POS user information (e.g., contact information), etc. (i.e., “user input”), via the GUI of the POS client device 212A. The user input may be sent from the POS client device 212A to the POS transaction server 202 via the network N and used by the processor 206 to generate a QR code 204E (e.g., based on processor-executable instructions stored in the memory 204 (not shown)). The generated QR code 204E may then be sent to the POS client device 212A, via the network N, from the POS transaction server 202 via the communications interface 208. Alternatively, the QR code may be generated locally within the POS client device 212A (e.g., using a software application stored thereon). Once the QR code is received at the POS client device 212A, the QR code is displayed via the GUI of the POS client device 212A, and the guest user uses his/her guest client device 212B to scan the QR code displayed via the GUI of the POS client device 212A, for example by holding the guest client device 212B in close proximity to the display of the POS client device 212A, with the camera of the guest client device 212B oriented such that it faces the display of the POS client device 212A. In response to scanning the QR code, a browser of guest client device 212B automatically navigates to a webpage (e.g., one of webpages 204K) prompting the user to pay for the transaction, and presenting representations of one or more payment methods by which the guest user may complete the transaction (e.g., as shown and described with reference to FIG. 1). Completion of the transaction may involve communications among the guest client device 212B, the POS transaction server 202, and the one or more remote compute device 210 (e.g., including a payment gateway, similar to the payment gateway module 110 of FIG. 1). Data associated with completed transactions can be sent to the POS transaction server 202 and stored as transaction data 204D. In some implementations, transaction data can also be recorded in a distributed ledger (e.g., a blockchain) (not shown).

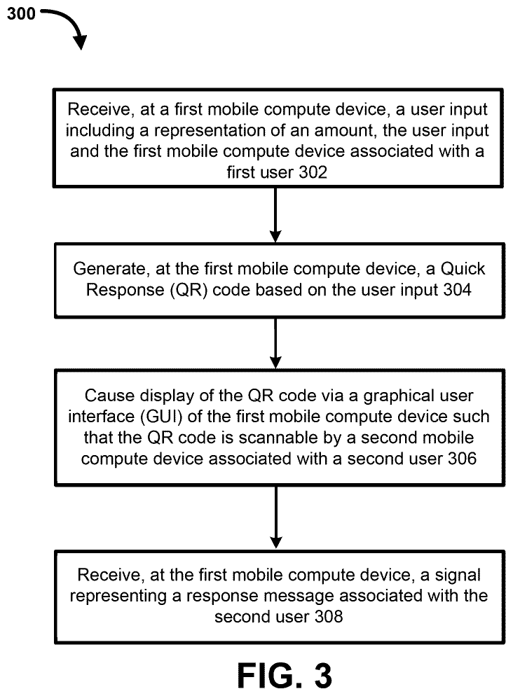

FIG. 3 is a flow diagram showing a first method for processing web-mediated transactions, from the point of view of a “point-of-sale” compute device (e.g., the POS client device 212A of FIG. 2), according to some embodiments. As shown in FIG. 3, the method 300 includes receiving, at 302 and at a processor of a first mobile compute device (e.g., a “point-of-sale” compute device), a user input including a representation of an amount of money (and, optionally, a comment and/or an invoice identifier). The user input and the first mobile compute device are associated with a first user. The method 300 also includes generating, at 304 and at the processor of the first mobile compute device, a quick response (QR) code based on the user input, and causing display, at 306, of the QR code via a graphical user interface (GUI) of the first mobile compute device such that the QR code is scannable by a second mobile compute device associated with a second user. The method 300 also includes receiving, at 308 and at the processor of the first mobile compute device, a signal representing a response message associated with the second user. The response message includes an indication of a payment status for a payment initiated based on the QR code and authorized by the second user. The payment status can include, for example, “approved,” “pending,” “declined,” “timed out,” “verification needed,” etc. The response message can be, for example, a response received from a payment gateway.

In some implementations, an invoice identifier is automatically generated by at least one of a client compute device (e.g., the first mobile compute device) or a server, in response to and based on the user input.

In some implementations, the generating the QR code is in response to an interaction of the first user with the GUI. The interaction may include, for example, a touch selection of a graphical object such as a button, a text entry, and/or a voice command.

In some implementations, the amount includes at least one of an amount of currency, a quantity of one or more goods, or a quantification of one or more services.

In some implementations, the method 300 also includes causing display of the response message via the GUI of the first mobile compute device. The display of the response message via the GUI of the first mobile compute device can be performed substantially concurrently with display of the response message via a GUI of the second mobile compute device. As used herein, “substantially concurrently” can refer to events that take place at the same time when adjusted for processing-related delays (e.g., computation delay, transmission delay, etc.), or can refer to events that overlap in time, such as the display of the QR code via multiple mobile compute devices during a common period of time.

In some implementations, the QR code is configured to cause a browser of the second mobile compute device to navigate to a webpage in response to the QR code being scanned by the second mobile compute device. The webpage can include the representation of the amount (and, optionally, the comment and/or the invoice identifier). The navigation can be completed using functionality built into a smartphone, such as via a camera software application. A camera software application can be configured to scan the QR code and read the web URL embedded within/represented by the QR code. In response to identifying the web URL, the camera software application can present a user-selectable option to navigate to the URL (or automatically trigger navigation to the URL) using a web browser (e.g., a default web browser of the smartphone).

In some implementations, the amount of money (and, optionally, the comment and/or the invoice identifier) is associated with a set of at least one product, and in some such implementations, the webpage does not include product information for any product different from the set of at least one product. In other such implementations, the webpage includes one or more product-related features, such as information regarding one or more “products related to” and/or “services related to” the at least one product, and/or one or more product or service recommendations. The one or more product or service recommendations can be generated at the first mobile compute device (or generated at a remote compute device and received at the first mobile compute device), for example based on one or more detected shopping trends of the first user, one or more detected shopping trends associated with a networked plurality of compute devices including the first mobile compute device, and/or a browser history of the first user.

In some implementations, the amount (and, optionally, the comment and/or the invoice identifier) is associated with a set of at least one service, and the webpage does not include service information for any service different from the set of at least one service. In other such implementations, the webpage includes one or more service-related features, such as information regarding one or more “products related to” and/or “services related to” the at least one service, and/or one or more product or service recommendations. The one or more product or service recommendations can be generated at the first mobile compute device (or generated at a remote compute device and received at the first mobile compute device), for example based on one or more detected shopping trends of the first user, one or more detected shopping trends associated with a networked plurality of compute devices including the first mobile compute device, and/or a browser history of the first user.

In some implementations, the user input further includes a representation of a comment related to the amount of money.

In some implementations, the generating the QR code is further based on an invoice identifier that is automatically generated in response to the user input.

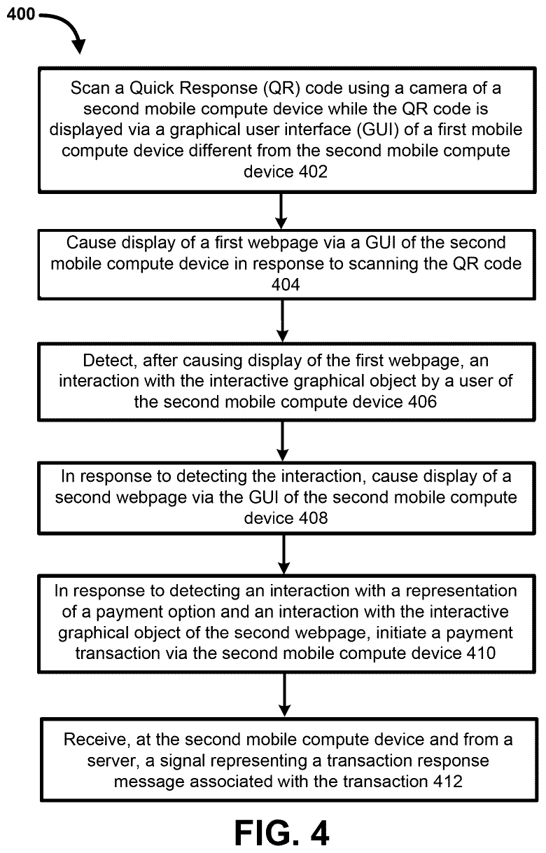

FIG. 4 is a flow diagram showing a method for processing web-mediated transactions, from the point of view of a “guest” compute device (e.g., the guest client device 212B of FIG. 2), according to some embodiments. As shown in FIG. 4, the method 400 includes scanning a quick response (QR) code, at 402, using a camera of a second mobile compute device (e.g., a “guest” compute device), while the QR code is displayed via a graphical user interface (GUI) of a first mobile compute device different from the second mobile compute device. The method 400 also includes causing display, at 404, of a first webpage via a GUI of the second mobile compute device in response to scanning the QR code. The first webpage includes a representation of a price, a representation of at least one product, and an interactive graphical object. After causing display of the first webpage at 404, an interaction with the interactive graphical object by a user of the second mobile compute device is detected at 406. The method 400 also includes causing display at 408 of a second webpage via the GUI of the second mobile compute device, in response to detecting the interaction with the interactive graphical object at 406. The second webpage includes a plurality of representations of payment options and an interactive graphical object. The method 400 also includes initiating a payment transaction, at 410, via a processor of the second mobile compute device in response to detecting an interaction with a representation of a payment option from the plurality of representations of payment options and an interaction with the interactive graphical object of the second webpage. The method 400 also includes receiving, at 412, at the processor of the second mobile compute device and from a server, a signal representing a transaction response message associated with the transaction.

In some implementations, the method 400 also includes causing display of a user-understandable message representing the transaction response message via the GUI of the second mobile compute device. The display of the response message via the GUI of the second mobile compute device can be performed substantially concurrently with display of the response message via the GUI of the first mobile compute device.

In some implementations, the interactive graphical object of the first webpage includes one of a text button, a ghost button, a raised button, a toggle button, or a floating action button.

In some implementations, the first webpage also includes text entered by a user associated with the first mobile compute device.

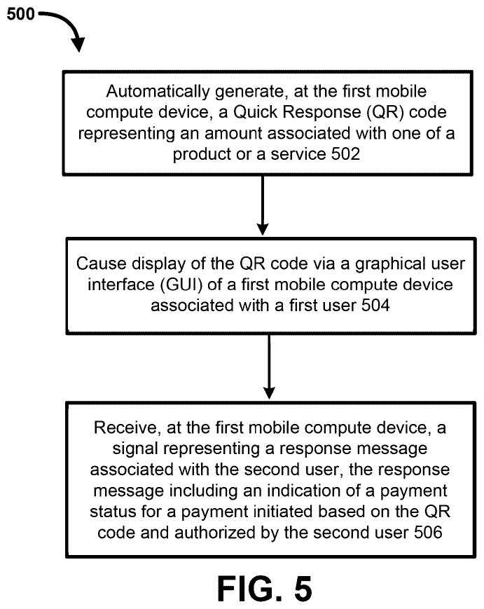

FIG. 5 is a flow diagram showing a second method for processing web-mediated transactions, from the point of view of a “point-of-sale” compute device (e.g., the POS client device 212A of FIG. 2), according to some embodiments. As shown in FIG. 5, the method 500 includes automatically generating, at 502, at the processor of the first mobile compute device, a quick response (QR) code representing an amount associated with one of a product or a service, and causing display at 504 of the QR code via a graphical user interface (GUI) of a first mobile compute device associated with a first user, such that the QR code is scannable by a second mobile compute device associated with a second user. The method 500 also includes receiving, at 506, at the processor of the first mobile compute device, a signal representing a response message associated with the second user. The response message includes an indication of a payment status for a payment initiated based on the QR code and authorized by the second user.

In some implementations, the response message includes a software token.

In some implementations, the method 500 also includes causing storage, at a remote compute device, of transaction data associated with the QR code, for example to track transactions as they occur over time.

In some implementations, the method 500 also includes causing display of a loading icon via the GUI of the first mobile compute device after causing display of the QR code via the GUI of the first mobile compute device and before receiving the signal representing the response message. For example, the loading icon can be displayed via the GUI of the first mobile compute device while the second user is completing a payment process.

In some implementations, payment data and/or transaction data are transmitted to one or both of a bank of a purchaser (or “guest user”) and a bank of a vendor (or “POS user”).

In some implementations, no token is generated in connection with the transaction (e.g., where payment information can be securely transmitted directly to a payment processor without passing through an intervening gateway).

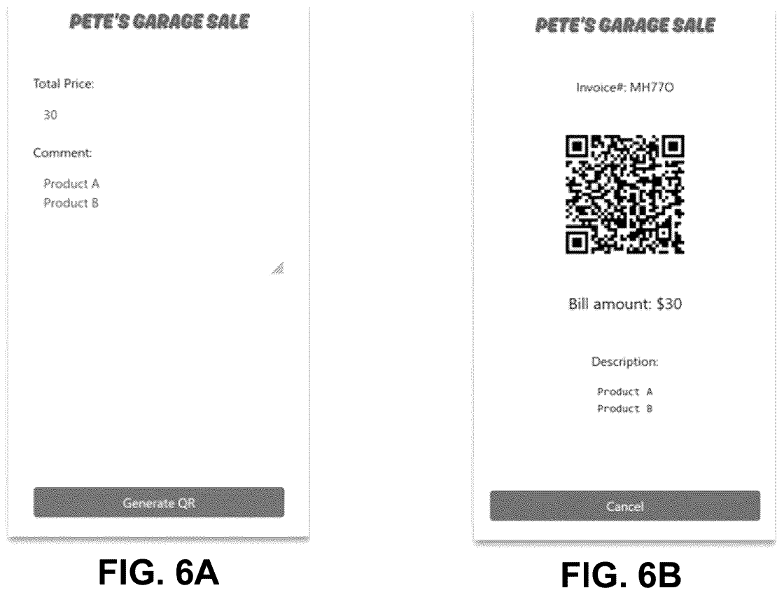

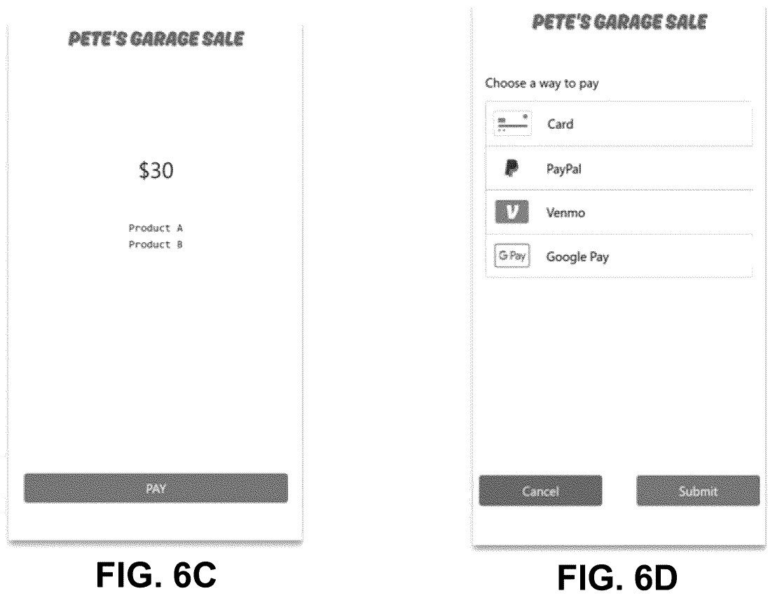

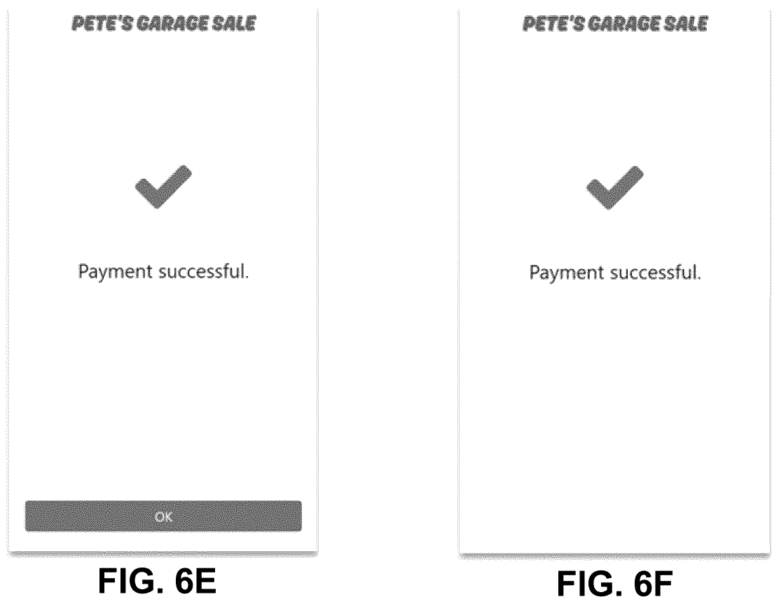

FIGS. 6A-6F show an example sequence of information displayed via graphical user interfaces (GUIs) of a POS compute device and a guest compute device during a transaction, according to an embodiment. FIG. 6A shows a GUI screen of a POS compute device of a seller at a garage sale (“Pete's Garage Sale”) who desired to charge a customer for a transaction. The GUI screen of FIG. 6A appears after the seller logs into a web-based application (“web app”) or a mobile software application (“mobile app”), and includes a fillable form with textboxes where the seller can enter a total price (here, 30) and a comment (here, “Product A” and “Product B”). The GUI screen of FIG. 6A also includes a user-selectable object (button) for generating a QR code. In some implementations, the total price is a required field, in that the button for generating a QR code is deactivated until the total price field has been populated. In some implementations, the comment field is an optional field, in that the button for generating a QR code may be activated/selectable regardless of whether the comment field has been populated.

When the seller selects (e.g., clicks on) the “Generate QR” button, and in response to the seller selecting the “Generate QR” button, the information entered by the seller via the GUI screen of FIG. 6A is sent to a server (e.g., including functionality such as QR code generation module 102 of FIG. 1, and/or similar to the POS transaction server 202 of FIG. 2) that generates a QR code for the transaction. The QR code and, optionally, supplemental data (e.g., invoice number, text such as “Bill amount” and “Description,” etc.) is sent to the POS compute device for display thereon, as shown in FIG. 6B.

The seller can show the QR code to the customer, who in turn can scan or otherwise capture an image of the QR code with the camera of his/her compute device (guest compute device). In response to capturing the QR code with their guest compute device, a browser of the guest compute device automatically navigates to a webpage, which may present as shown in FIG. 6C. As shown in FIG. 6C, the webpage is relatively sparse, in that a price and optional comment are shown (e.g., “Product A” and “Product B”), along with a user-selectable “Pay” button, but otherwise does not include any other information. For example, the webpage has a blank white background, and does not include any advertisements. Although not shown in FIGS. 6A-6E, in some implementations, an address bar, a displayed URL, one or more additional graphics, and/or additional text may be shown within the viewable area of the webpage.

When the customer selects (e.g., clicks on) the Pay button in the webpage of FIG. 6C, the browser of the guest compute device automatically redirects to the webpage shown in FIG. 6D, which provides payment options from which the guest user may select, as discussed above. As the customer navigates from the webpage of FIG. 6C to the webpage of FIG. 6D, the POS compute device continues to display the contents of FIG. 6B.

If the customer decides that he/she no longer desires to complete the transaction, the customer can select the “Cancel” button shown in FIG. 6D. Alternatively, once the customer has selected a payment option (and, optionally, has completed a payment process with the selected payment processor), the user can select the “Submit” button shown in FIG. 6D. In response to the selection of the “Submit” button, a token including a representation of the completed payment is automatically sent to the server, and the server may forward the token to a payment gateway to charge the amount. A payment confirmation message can then be displayed at both the POS compute device and the guest compute device, as shown in FIGS. 6E and 6F, respectively. As shown in FIG. 6E, the payment confirmation message displayed via the POS compute device may include an acknowledgment (“OK”) button, so that the merchant/POS user can begin a new transaction. The payment confirmation message displayed via the guest compute device may not include an acknowledgment (“OK”) button (as shown in FIG. 6F), or in other implementations, may include an acknowledgment (“OK”) button that, when selected by the guest user, causes the browser window to close and/or a session associated with the transaction to end.

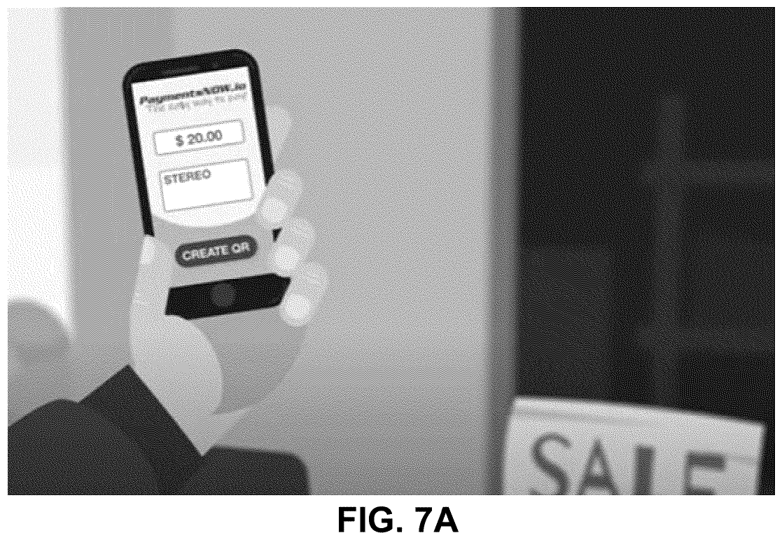

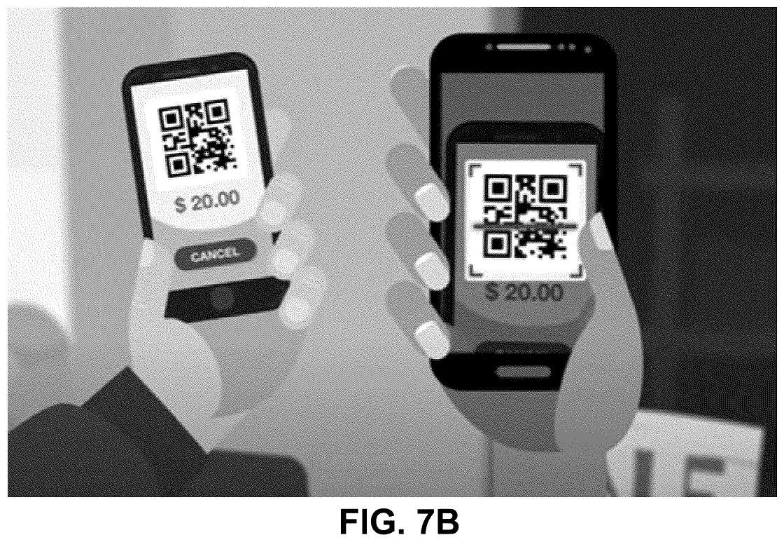

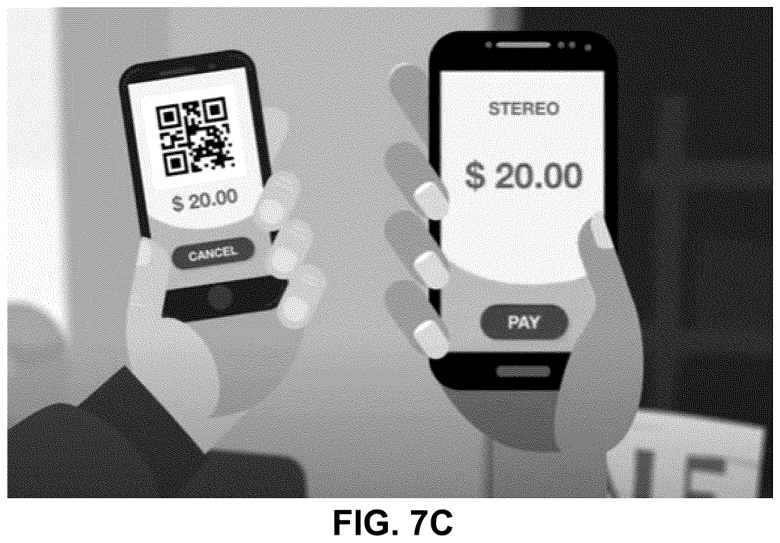

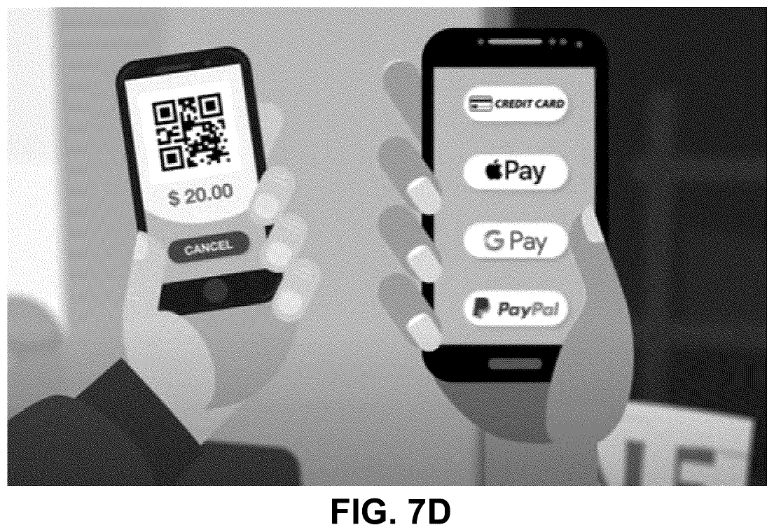

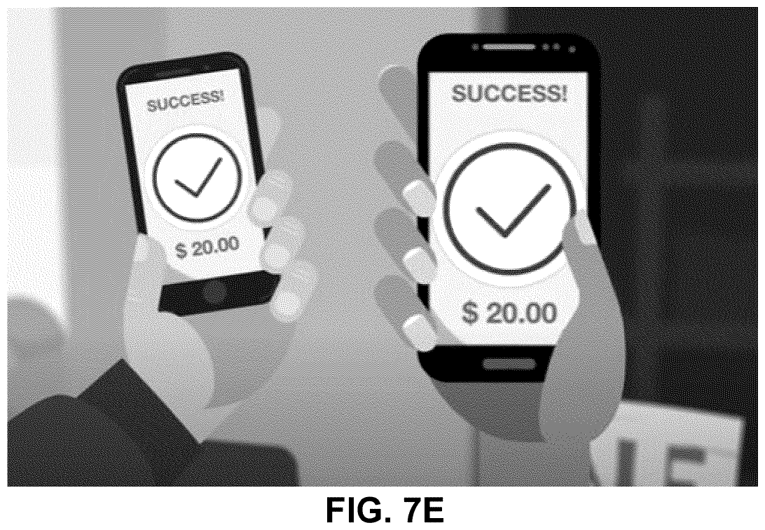

FIGS. 7A-7E show an example sequence of actions taken and information displayed via GUIs of a point-of-sale compute device and a guest compute device during a transaction, according to an embodiment. As shown in FIG. 7A, a POS user enters user input, including an amount (price) and a comment describing the good to be purchased (a STEREO), via a GUI of a POS mobile compute device. In response to submitting the user input (e.g., by pressing the “CREATE QR” button shown in FIG. 7A), a QR code generated based on the user input is generated as discussed above, and displayed via the GUI of the POS compute device (shown on the left in FIG. 7B). A customer/purchaser scans the QR code using a camera/scanner of their compute device (i.e., a guest compute device), as shown on the right side of FIG. 7B. In response to scanning the QR code, a browser of the guest compute device navigates to a webpage showing the details of the proposed transaction (“STEREO” and “$20.00”), with a user-selectable button to pay, as shown in FIG. 7C. In response to the customer selecting the “PAY” button shown in FIG. 7C, the browser of the guest compute device navigates to a webpage showing user-selectable payment options, as shown on the right side of FIG. 7D. While the user-selectable payment options are displayed via the guest compute device, the QR optionally remains displayed via the POS compute device, as shown on the left side of FIG. 7D. As an alternative to what is shown on the left side of FIG. 7D, a loading icon (“throbber”) or other animated graphical control element may be displayed via the POS compute device while the user-selectable payment options are displayed via the guest compute device. In response to the customer selecting a payment option from the user-selectable payment options shown in FIG. 7D, and completing the payment via the payment processor of choice, a “SUCCESS” message is displayed simultaneously or substantially concurrently via each of the POS compute device and the guest compute device, as shown in FIG. 7E, to indicate to both the seller and the customer that the transaction has been completed.

In various embodiments, as discussed above, transactions facilitated by the present disclosure include the scanning, by a guest compute device, of a QR code, and the navigation of a browser of the guest compute device to a webpage associated with the transaction, in response to the scanning of the QR code. In some such implementations, the transaction is completed without the use of any locally-installed software applications on the guest compute device, apart from the browser itself.

In an alternative embodiment, a transaction can include running a software application on a guest compute device, the software application configured to listen for/detect a first Bluetooth® communication from a POS compute device. The first Bluetooth® communication can include an instruction to cause display of product and price information via a GUI of the guest compute device (e.g., by causing a browser of the guest compute device to navigate to a website containing such information). The product and price information may be entered by a POS user vis the POS compute device prior to the Bluetooth® communication being sent from the POS compute device. The foregoing steps may be performed in lieu of the display of a QR code via a display of the POS compute device and the scanning of the displayed QR code using the guest compute device. Similarly, once the POS user has made one or more selections at the webpage and completed payment, and in response to receiving a payment confirmation message, the software application may generate and send, to the POS compute device, a second Bluetooth® communication to cause display of the payment confirmation message via the display of the POS compute device.

All combinations of the foregoing concepts and additional concepts discussed herewithin (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including Python, C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure.

1. A method, comprising:
receiving, at a processor of a first mobile compute device, a user input including a representation of an amount, the user input and the first mobile compute device associated with a first user;
generating, at the processor of the first mobile compute device, a quick response (QR) code based on the user input;
causing display of the QR code via a graphical user interface (GUI) of the first mobile compute device such that the QR code is scannable by a second mobile compute device associated with a second user; and
receiving, at the processor of the first mobile compute device, a signal representing a response message associated with the second user, the response message including an indication of a payment status for a payment initiated based on the QR code and authorized by the second user.

2. The method of claim 1, wherein the generating the QR code is in response to an interaction of the first user with the GUI.

3. The method of claim 2, wherein the interaction of the first user with the GUI is a touch selection of a button.

4. The method of claim 1, further comprising causing display of the response message via the GUI of the first mobile compute device.

5. The method of claim 4, wherein the display of the response message via the GUI of the first mobile compute device is performed substantially concurrently with display of the response message via a GUI of the second mobile compute device.

6. The method of claim 1, wherein the QR code is configured to cause a browser of the second mobile compute device to navigate to a webpage in response to the QR code being scanned by the second mobile compute device.

7. The method of claim 6, wherein the webpage includes the representation of the amount.

8. The method of claim 7, wherein the at least one of the amount, the comment, or the invoice identifier is associated with a set of at least one product, and the webpage does not include product information for any product different from the set of at least one product.

9. The method of claim 7, wherein the at least one of the amount, the comment, or the invoice identifier is associated with a set of at least one service, and the webpage does not include service information for any service different from the set of at least one service.

10. The method of claim 1, wherein the user input further includes a representation of a comment related to the amount.

11. The method of claim 1, wherein the generating the QR code is further based on an invoice identifier that is automatically generated in response to the user input.

12. A method, comprising:
scanning a quick response (QR) code using a camera of a second mobile compute device while the QR code is displayed via a graphical user interface (GUI) of a first mobile compute device different from the second mobile compute device;
causing display of a first webpage via a GUI of the second mobile compute device in response to scanning the QR code, the first webpage including a representation of a price, a representation of at least one product, and an interactive graphical object;
detecting, after causing display of the first webpage, an interaction with the interactive graphical object by a user of the second mobile compute device;
in response to detecting the interaction with the interactive graphical object, causing display of a second webpage via the GUI of the second mobile compute device, the second webpage including a plurality of representations of payment options and an interactive graphical object;
in response to detecting an interaction with a representation of a payment option from the plurality of representations of payment options and an interaction with the interactive graphical object of the second webpage, initiating a payment transaction via a processor of the second mobile compute device; and
receiving, at the processor of the second mobile compute device and from a server, a signal representing a transaction response message associated with the transaction.

13. The method of claim 12, further comprising causing display of a user-understandable message representing the transaction response message via the GUI of the second mobile compute device.

14. The method of claim 13, wherein the display of the response message via the GUI of the second mobile compute device is performed substantially concurrently with display of the response message via the GUI of the first mobile compute device.

15. The method of claim 12, wherein the interactive graphical object of the first webpage includes one of a text button, a ghost button, a raised button, a toggle button, or a floating action button.

16. The method of claim 12, wherein the first webpage further includes text entered by a user associated with the first mobile compute device.

17. A method, comprising:
automatically generating, at the processor of the first mobile compute device, a quick response (QR) code representing an amount associated with one of a product or a service;
causing display of the QR code via a graphical user interface (GUI) of a first mobile compute device associated with a first user, such that the QR code is scannable by a second mobile compute device associated with a second user; and
receiving, at the processor of the first mobile compute device, a signal representing a response message associated with the second user, the response message including an indication of a payment status for a payment initiated based on the QR code and authorized by the second user.

18. The method of claim 17, wherein the response message includes a software token.

19. The method of claim 17, further comprising causing storage, at a remote compute device, of transaction data associated with the QR code.

20. The method of claim 17, further comprising causing display of a loading icon via the GUI of the first mobile compute device after causing display of the QR code via the GUI of the first mobile compute device and before receiving the signal representing the response message.
